(19) United States
(12) Patent Application Publication
(10) Pub. No.: US 2014/0039953 A1
(43) Pub. Date: Feb. 6, 2014

(54) TRANSPORT SYSTEM AND METHOD

(71) Applicant: GENERAL ELECTRIC COMPANY, Schenectady, NY (US)

(72) Inventor: EDWARD MCQUILLAN, LISLE, IL (US)

(21) Appl. No.: 13/943,819

(22) Filed: Jul. 17, 2013

Related U.S. Application Data
(60) Provisional application No. 61/677,598, filed on Jul. 31, 2012.

(51) Int. Cl. G06Q 10/06

(52) U.S. Cl. CPC G06Q 10/06312
USPC 705/7.13; 705/7.22

(57) ABSTRACT

Systems and methods of the invention relate to distributing transports to reduce travel time and/or travel distance for the movement of assets within a distribution center. Embodiments of the present invention include a transport manager that communicates real time transport itineraries that assign transport(s) based on proximity of an employee or equipment and a start location of a transport. Moreover, the transport manager can utilize a geographic location of the equipment and/or the employee to assign transports in order to reduce a distance traveled for a transport or reduce a travel time for a transport.

### CROSS-REFERENCE TO RELATED APPLICATIONS

This application claims the benefit of U.S. Provisional Application Ser. No. 61/677,598, filed Jul. 31, 2012, and entitled “TRANSPORT SYSTEM AND METHOD.” The entirety of the aforementioned application is incorporated herein by reference.

### BACKGROUND

1. Technical Field

Embodiments of the subject matter disclosed herein relate to a transport management system for an asset in a distribution center or other area.

2. Discussion of Art

Distribution center activity may include transports of assets from one location to another location. Based on the volume of transports and limited amount of equipment (e.g., controlled or operated by workers) to transport the assets within the distribution center, order fulfillment time may not be as fast as desired. A work order may be assigned for each transport based on worker/equipment availability to collect such work order from a centralized location in the distribution center.

It may be desirable to have a system and method for managing transport systems that differ from those that are currently available.

### BRIEF DESCRIPTION

In one embodiment, a method is provided. The method includes at least the following steps: identifying two or more transports from a work order, wherein the transports comprise respective movements of assets from respective first locations to respective second locations; prioritizing the two or more transports based on a geographic proximity between the movements of the two or more transports; and communicating information of the two or more transports as prioritized to equipment to complete the movements.

In an embodiment, a system is provided that includes a transport manager configured to store a work order and to identify two or more transports from the work order, wherein the transports comprise respective movements of assets from respective first locations to respective second locations; wherein the transport manager is configured to prioritize the two or more transports based on a geographic proximity between the movements of the two or more transports, and to communicate information of the two or more transports as prioritized to equipment to complete the movements.

In an embodiment, a system is provided that includes at least the following: a work order that defines two or more transports, wherein the transports comprise respective movements of assets from respective first locations in a distribution center to respective second locations in the distribution center; and a transport manager configured to receive a geographic location of at least one of a worker or equipment from a device, and to create a transport itinerary that combines at least two of the two or more transports based on an amount of distance traveled for each asset of each transport from the geographic location of the worker or the equipment; wherein the transport manager is further configured to communicate the transport itinerary to the device.

In an embodiment, a system is provided that includes at least the following: means for defining two or more transports, wherein the transports comprise respective movements of assets from respective first locations in a distribution center to respective second locations in the distribution center; means for receiving a geographic location of at least one of a worker or equipment from a device, and to create a transport itinerary that combines at least two of the two or more transports based on an amount of distance traveled for each asset of each transport from the geographic location of the worker or the equipment; and means for communicating the transport itinerary to the device.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for distributing transports to reduce travel time and/or travel distance for the movement of assets within a distribution center;

FIG. 2 is an illustration of an embodiment of a system for managing transports of assets within a distribution center;

FIG. 3 illustrates a flow chart of an embodiment of a distribution center transport itinerary;

FIG. 4 is an illustration of an embodiment of a system for modeling a distribution center and transports associated therewith;

FIG. 5 is an illustration of a screenshot associated with transport activity;

FIG. 6 is an illustration of graphs related to collecting data for workers;

FIG. 7 is an illustration of a graph related to work orders;

FIG. 8 is an illustration of an embodiment of a system for managing transports of assets within a distribution center; and

FIG. 9 illustrates a flow chart of an embodiment of a method for distributing transports to reduce travel time and/or travel distance for the movement of assets within a distribution center.

### DETAILED DESCRIPTION

Embodiments of the invention relate to methods and systems for transport management. Such systems may reduce travel time and/or travel distance for the movement of assets within a distribution center. In particular, equipment and/or an worker can receive real time transport itineraries that assign transport(s) based on a set of factors. Suitable factors may include proximity of the worker or the equipment and a start location of the transport; types of equipment, health of equipment, remaining time left on an worker's shift, type of asset to be moved, type of vehicle the asset will be loaded onto, and other prioritization factors. A geographic location of the equipment and/or the worker can be utilized to assign transports in order to reduce a distance traveled for a transport or reduce a travel time for a transport. The transports and/or the transport itinerary can be communicated for dynamic management of asset transport and movement within a distribution center or other area.

The term “client asset” as used herein means a fixed asset or a mobile asset that is owned and/or operated by a client entity such as, for example, a railroad, a power generation company, a shipping company (e.g., land, sea, air, and/or a combination thereof), a mining equipment company, an airline, or another asset-owning and/or asset-operating entity. The terms “container” and “trailer” may be used interchangeably herein and refer to a storage medium configured to hold products, goods, or other shippable materials.

The term “vehicle” as used herein can be defined as an asset that is a mobile machine that transports at least one of a person, people, or a cargo. For instance, a vehicle can be, but is not limited to being, a truck, a rail car, an intermodal container, a locomotive, a marine vessel, a mining equipment, a stationary power generation equipment, an industrial equipment, a construction equipment, and the like. The term “hostler” as used herein can be defined as a person or machine that operates a vehicle to perform the transport of a container or trailer from a first location to a second location. The terms “terminal”, “yard”, or “distribution center” may be used interchangeably herein and refer to a location and/or facility where products, goods, or other shippable materials are shipped into and subsequently shipped out of by drivers of shipping vehicles.

“Software” or “computer program” as used herein includes, but is not limited to, one or more computer readable and/or executable instructions that cause a computer or other electronic device to perform functions, actions, and/or behave in a desired manner. For example, a component can be a portion of hardware, a portion of software, and/or a combination thereof. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. The form of software may depend on, for example, requirements of a desired application, the environment it runs on, and/or the desires of a designer/programmer or the like. “Computer” or “processing element” or “computer device” as used herein includes a programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or program involved in controlling an energy storage system. The terms “signal”, “data”, and “information” may be used interchangeably herein and may refer to digital or analog forms.

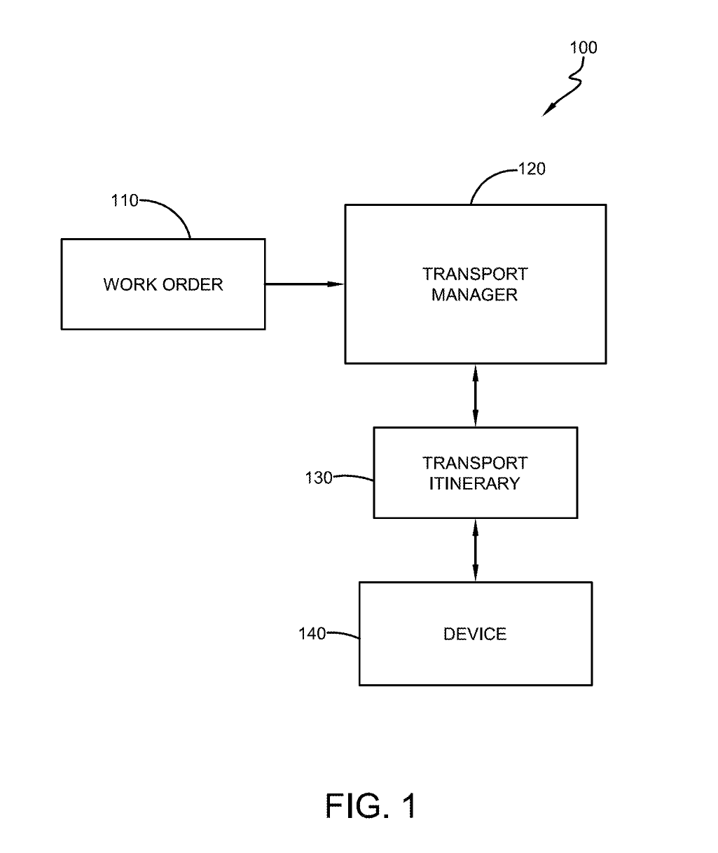

FIG. 1 is an illustration of an embodiment of a system 100 for distributing transports to reduce travel time and/or travel distance for the movement of assets within a distribution center. The system can include a transport manager 120 that prioritizes a work order 110 for a distribution center in order to improve the transport of assets therein. The work order can be instructions related to a transport, wherein a transport is a movement of an asset from a first location to a second location in the distribution center. The transport manager can create a transport itinerary 130 based upon the work order in which the transport itinerary is assigned to at least one of equipment or an worker to handle transfer (e.g., complete the transport movement(s) from the first location to the second location) of at least one asset. The transport itinerary is created and utilized to assign transfer of assets in which a travel time for an asset is reduced, a travel time for equipment or worker transferring the asset is reduced, or an amount of distance traveled for the asset is reduced. The transport manager can be a separate device (as illustrated), incorporated into an existing system (e.g., computer system, hardware system, device, computer, among others), and/or a combination thereof. For example, in embodiments, the transport manager comprises an electronic device having a processor, e.g., the transport manager may comprise a computer in combination with software stored on the computer where the software includes instructions that when executed by the processor of the computer cause the processor to execute the functionality described herein, and where the computer may perform only the functions of the transport manager or may perform other functions in addition.

The work order can be an instruction (e.g., written, digital, verbal, among others) in which an asset in the distribution center is to be transported from a first location to a second location. Moreover, the work order can include one or more transports in which a transport is a movement from a first location to a second location within the distribution center. (That is, the transports are respective movements of assets from respective first locations to respective second locations, e.g., the assets may be moved from the same first location to the same second location, or moved between different first and second locations.) Additionally, the work order can include a pickup, a drop off, and/or a suitable combination thereof. Moreover, the transport that includes a movement from a first location to a second location can be a pickup of an asset, a drop off of an asset, and/or a suitable combination thereof. For instance, a movement from a first location to a second location can be a pickup (e.g., pickup at first location and drop off at second location), a drop off (e.g., drop off of an asset at second location from first location being present location) of an asset, or a combination of a pickup and drop off (e.g., drop off at first location and pickup at second location) of an asset. The work order can also include a suitable number of movements (e.g., pickups, drop offs, or a combination thereof).

In one embodiment, hostlers are shown what containers need to be extracted from the yard (e.g., distribution center) for dispatch (e.g., transport from a first location to a second location). The hostlers self-prioritize by working in teams and “own” rows or sections of the yard such that owning a row or section indicates responsibility for transport therein. Using an algorithm, tools, and/or screens, an embodiment may affect the efficiency of assigning transfer of assets. Some embodiments of the invention can bring containers from the distribution center to an outbound vehicle, location, train, on-road driver, among others. The transport manager can assign a sequence of work orders (that include transports of assets) through a device (e.g., handheld, in-dash console, among others) to decrease the travel time for each transport and/or decrease a distance traveled for the asset being transferred (e.g., thereby improving the retrieval and/or load up process). The transport manager further allows for re-sequencing (e.g., adjusting a prioritization, re-prioritizing, among others) in the case of a trigger event. Such triggers can include a task taking longer than an expected time, a change in customer prioritization, new hostler resources (e.g., equipment, tools, among others) being added/subtracted from availability, new work orders being added to the queue, an area specific event (discussed in more detail below), an amount of traffic, among others. Additionally, events may include one or more of rail network effects, weather, incoming container/trailer information, pricing events, value of assets, among others.

The distribution center can be a shipping terminal, a railroad intermodal terminal, a yard, a loading/unloading dock, or a location and/or facility where products, goods, or other shippable materials are shipped into and subsequently shipped out of by drivers of shipping vehicles. The containers or trailers containing the products, goods, or materials are processed in and out of the distribution center. Furthermore, the equipment can be a suitable mobile asset or vehicle that transfers assets from one location to another, wherein the equipment can include a load capacity. By way of example and not limitation, the transfer of an asset for a transport (e.g., a movement from a first location to a second location) can be handled or completed by a worker (e.g., employee, human, user, two or more workers, among others) or by a equipment (e.g., vehicle, mobile machine, crane, machine, forklift, employee controlling the equipment, machine-controlled equipment, among others).

As an option, the system may include a wireless communication (COMM) device (not shown) operably interfacing to the transport manager 120 and configured to communicate with other devices (e.g., via radio frequency communication, cellular, Radio Frequency (RF), among others) operating within the distribution center. Such other devices may be hand-held devices, in-console devices, devices used by inspectors, devices located in cranes or devices located on-site transportation vehicles within the distribution center, and are configured to communicate with the transport manager. By way of example and not limitation, the transport manager can communicate the transport itinerary via the wireless communication. As discussed, the transport itinerary can include instructions to complete two or more transports. Additionally, the transport itinerary can include directions associated with the assigned two or more transports.

The transport itinerary can be communicated to a device 140 in via suitable medium. Suitable mediums can include wired, air, wireless, and/or a combination thereof. By way of example and not limitation, the device can receive the transport itinerary with two or more prioritized transports for assignment, wherein the assignment can be indicated by a receipt by a particular device (e.g., a device for a worker, a device for equipment, among others). In another example, the assignment of the transport itinerary can be designated by at least one of a name of a worker or a identification of equipment. A suitable device can be a scanner, a barcode reader, a wireless device, a touchscreen, a camera, a smartphone, a laptop, a computer, a portable computing device, portable scanner, a mobile device, a portable digital assistant (PDA), a tablet, a web camera, a device incorporated into equipment, a device incorporated into a two-way communication device, hand-held device, in-console devices, devices used by inspectors, devices located in cranes or devices located on-site transportation vehicles within the distribution center, among others.

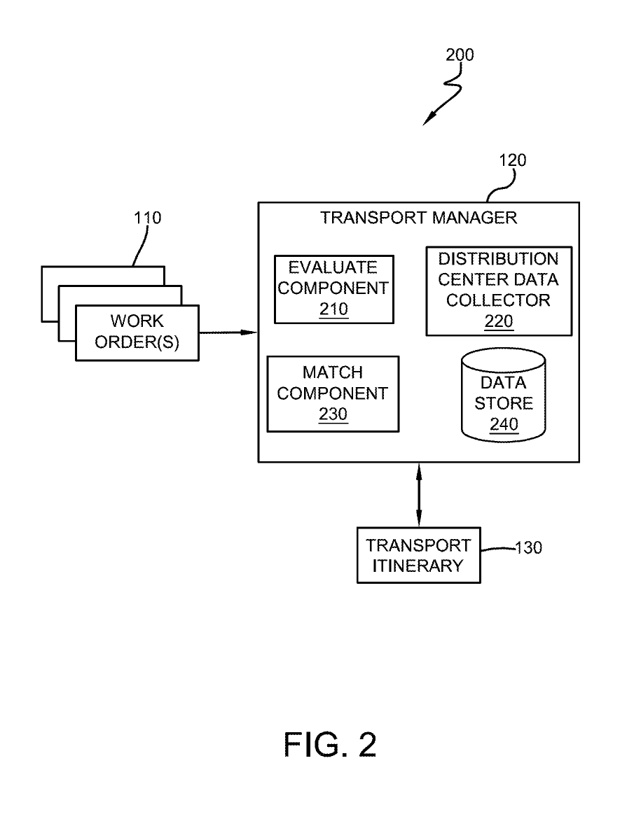

FIG. 2 is an illustration of a system 200 for managing transports of assets within a distribution center. The system includes the transport manager that prioritizes two or more transports associated with one or more work orders in order to create the transport itinerary that prioritizes the transports based on a geographic proximity between movements associated with each respective transport within such work order.

The transport manager can further include an evaluation component 210 that analyzes the one or more work orders. For instance, the evaluation component can identify information from the work order, such as an asset, an asset destination (e.g., a location to drop off an asset, among others), an asset location (e.g., a location to pickup an asset, among others), a definition of the asset (e.g., contents, cost, vendor, manufacturer, customer, among others), an asset size, and an asset weight, among others.

The transport manager further can include a distribution center data collector 220 that can aggregate data associated with at least one of the distribution center, the equipment, and/or at least one worker. For instance, the distribution center data collector can aggregate geographic location data (e.g., worker geographic location, equipment geographic location, locations for pickups, locations for drop offs, destinations for movements of a transport, among others), distribution information (e.g., distribution center layout, landmark locations, routes, directions between locations, names of locations, identifications of landmarks, among others), worker information (e.g., worker schedule, worker name, worker identification, worker experience with equipment, worker real time geographic location, among others), equipment information (e.g., equipment type, equipment load capacity, equipment status, among others), and the like. In an embodiment, a real time geographic location can be defined as a geographic location of an entity (e.g., person, item, equipment, vehicle, etc.) based on an electronic device that communicates such geographic data, wherein the delay of electronic signals is taken into account to determine a real time location based on the device.

The transport manager can further include a match component 230 that prioritizes two or more transports to package into the transport itinerary. For instance, the match component can combine two or transports into the transport itinerary for assignment to equipment or a worker for transfer (e.g., completion of the movement(s) of each transport). The combination can be such that the transports from the work orders are prioritized rather than handled in a sequential manner. For example, the match component can prioritize transports based upon a distance traveled for each movement such that a transfer will use the least amount of distance traveled. In another example, the match component can prioritize transports based upon a time for travel for each movement that a transfer of an asset uses. In still another example, the match component can prioritize transports of assets based upon the distance of the included movement(s) and a geographic location of a worker or equipment. The match component identifies efficient match making for two or more transports and at least one of a worker or equipment based on reducing distance traveled for the asset, reducing time traveled for the asset, among others. The match component can further utilize suitable factors to prioritize transports, wherein the factors can be, for instance, proximity of the worker or the equipment and a start location of the transport; types of equipment, health of equipment, remaining time left on an worker's shift, type of asset to be moved, type of vehicle the asset will be loaded onto, and other prioritization factors.

In another example, the match component can prioritize the two or more transports based on factors, such as traffic, an area specific event, an event trigger, and the like. For example, the match component can receive data related to an area specific event and include such condition in the prioritization and, in turn, assignment of transfer of an asset. An area specific event is an event occurring in an area or otherwise directly affecting operations in the area. For instance, the area specific event can be inoperable equipment, an unavailable worker, a construction of an area, a repair to an area, a power outage for the area, a repair to equipment, an emergency event in the area, a hazardous condition, and the like. In another example, the system can dynamically adjust prioritization of two or more transports based on traffic within the distribution center. Thus, if the assignment of transports is such that the location of workers and/or equipment is within a proximate geographic area of the distribution center, the match component can re-adjust accordingly in order to update upcoming work orders as well as, or in the alternative, re-assign work orders to alleviate the traffic.

In one embodiment, the transport manager stores information related to the system in a data store 240. The data store can include relationship information such as work order, distribution center information, worker information, transport information, asset data, transfer status, completed work orders, assignment data, prioritization data, time/date information, duration of transport, distance of transport, geographic locations, equipment information, equipment associated with the distribution center, and/or a suitable combination thereof.

The data store can be, for example, either volatile memory or nonvolatile memory, or can include both volatile and nonvolatile memory. The data store of the subject systems and methods is intended to comprise these and/or other types of memory. The data store can be a server, a database, a hard drive, a solid state drive, a pen drive, an external hard drive, a portable hard drive, a cloud-based storage, and the like.

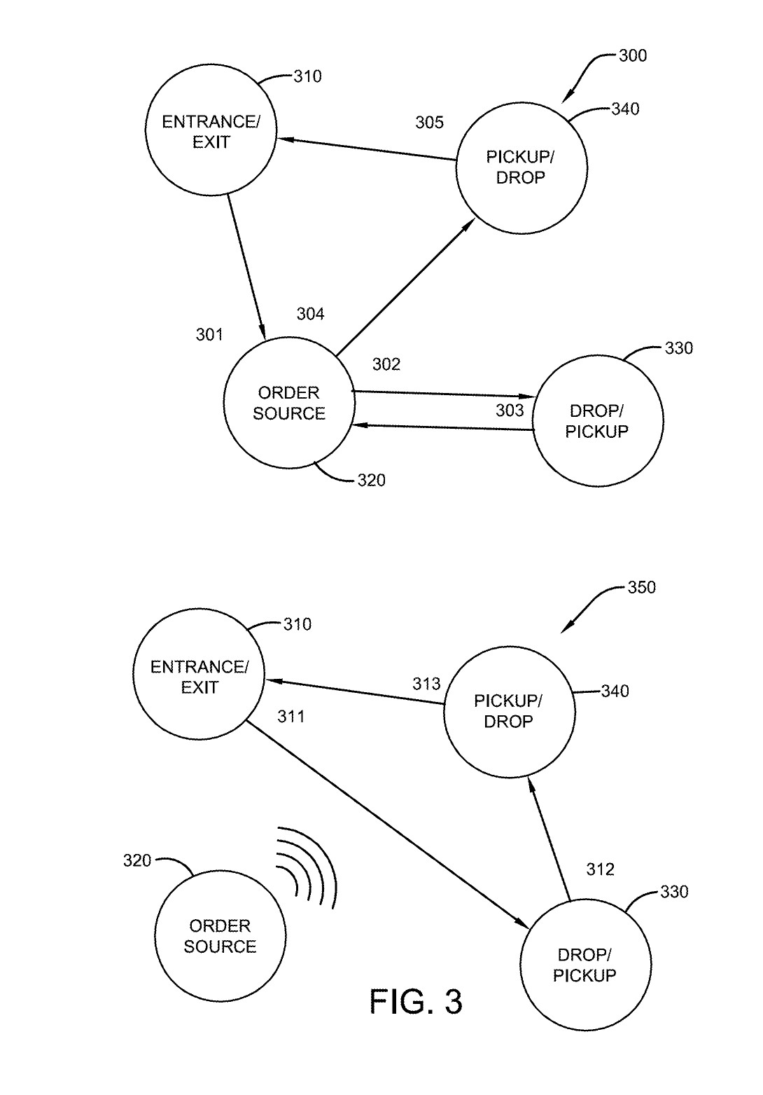

FIG. 3 illustrates flow charts 300, 350 of an embodiment of a distribution center transport itinerary. FIG. 3 is discussed with the use of a worker to complete the transfer of an asset from one location to another. The completed transfer can be performed by equipment, a user, and/or a combination thereof. FIG. 3 illustrates a flow chart 300 and a flow chart 350. The flow chart 300 illustrates a sequential work order flow in which worker enters a distribution center from an entrance/exit 310. At reference numeral 301, the worker travels to an order source 320 to receive a work order (e.g., the order source can be a user, a hub, and the like). At reference numeral 302, the worker travels to drop off the asset or pick up the asset (e.g., DROP/PICKUP 330) based on the work order. At reference numeral 303, the worker travels back to the order source 320 to receive another work order from the order source 320. At reference numeral 304, the worker travels to pickup or drop off the asset (e.g., PICKUP/DROP 340). At reference numeral 5, the worker travels to the entrance/exit 310 to exit. Thus, the travel time and travel distance is based on reference numerals 301, 302, 303, 304, and 305.

The flow chart 350 illustrates a transport prioritization technique as provided by the systems 100, 200, 400, and 800 utilizing at least the transport manager 120. The order source 320 can broadcast and/or communicate the work orders to the worker(s) based upon prioritization provided by the transport manager (not shown). At reference numeral 311, the worker enters the entrance/exit 310 and receives two or more transports that are assigned for transfer based on at least the movements of such transports as the worker is traveling. Once the transport itinerary depicting the transports is received, the worker travels to drop off the asset or pickup an asset (e.g., DROP/PICKUP 330) at reference numeral 311. At reference numeral 312, the worker travels to pick up an asset or drop off the asset (e.g., PICKUP/DROP 340). At reference numeral 313, the worker travels to the entrance/exit 310 completing the transport itinerary. Thus, the distance traveled for the asset(s) and/or the travel time for the asset(s) is reduced in flow 350 versus the flow in 300.

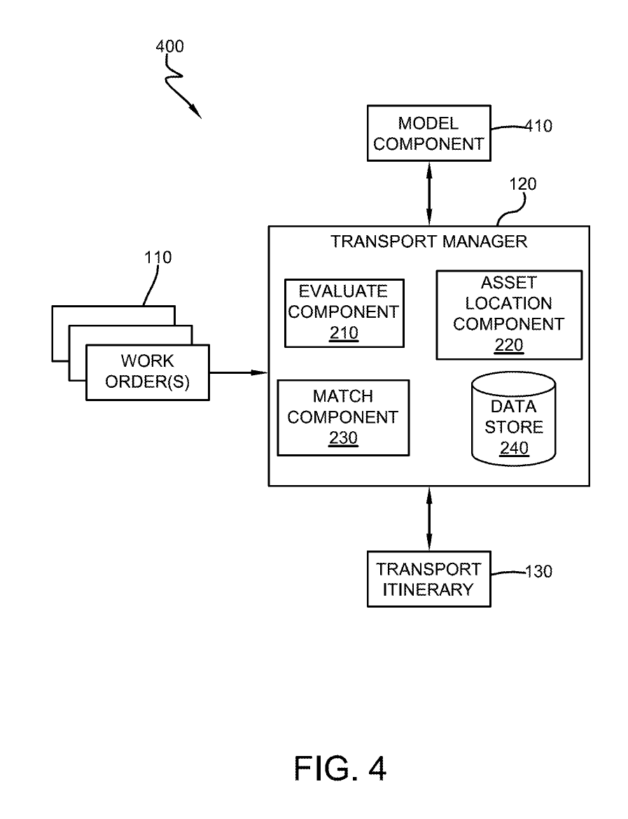

FIG. 4 is an illustration of a system 400 for modeling a distribution center and transports associated therewith. The system can include a model component 410 that represents a distribution center as a model in order to accurately estimate and calculate prioritization of transports in order to reduce travel time of assets, travel distance of assets, and/or improve efficiency of workers and/or equipment.

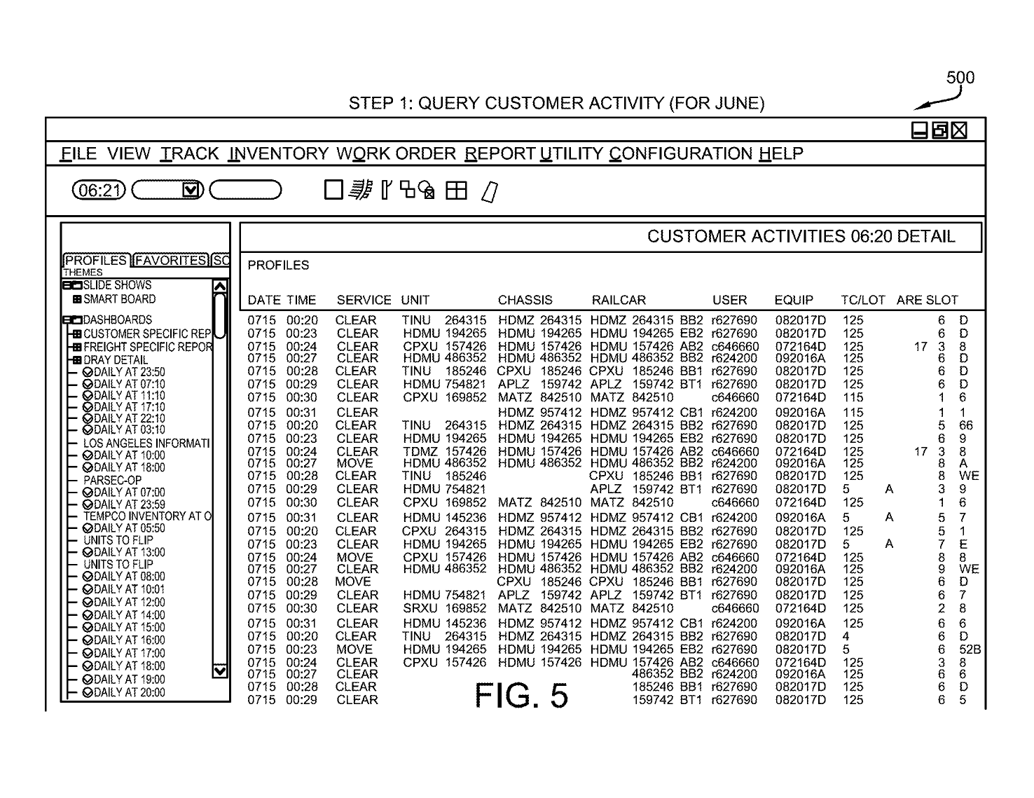

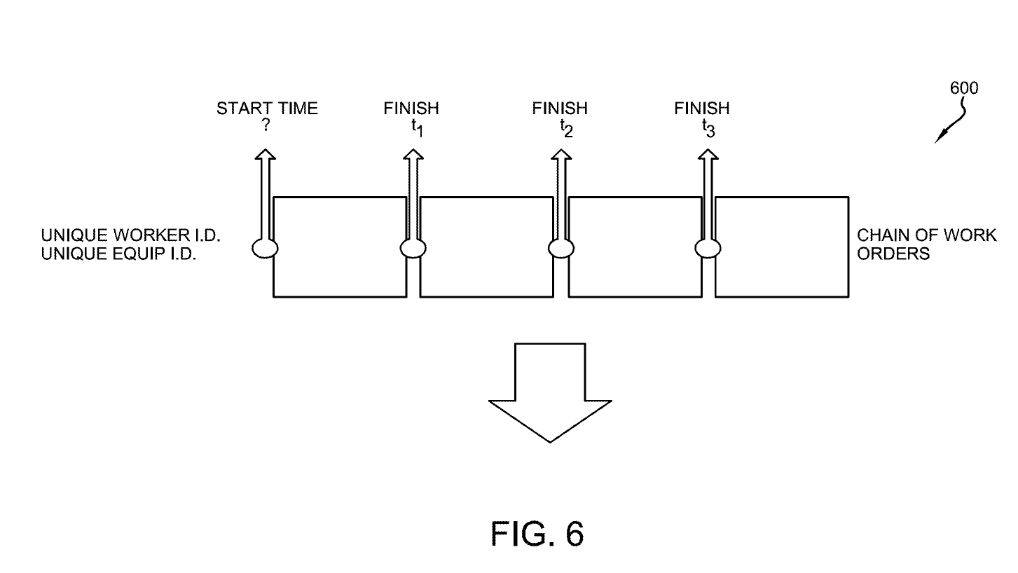

By way of example and not limitation, the model component can employ the following techniques. The model component can utilize data from, for instance, a client, customer, a distribution center, among others (See FIG. 5 and a screenshot 500 as an example). Turning briefly to FIG. 6, graph 600 is illustrated. The model component can collate data for workers in the distribution center. Each worker can include a worker identifier and equipment can include an equipment identifier. Chain of work orders can be received. The chains can be qualified by having a same worker ID and equipment ID; having a time between tasks (e.g., time between can be three (3) minutes apart, but no more than thirty (30) minutes apart); and partial records can be filtered out (e.g., user can have a number of characters, start and end lots may not be empty, etc.). Each work order (after the first) can reference three waypoints: the position of the worker before starting the work order; the start location of the work order; and the end location of the work order. Waypoints can be unique place strings, x-y coordinates, GPS locations, GPS locations, and/or other coordinates that designate a geographic location in the distribution center.

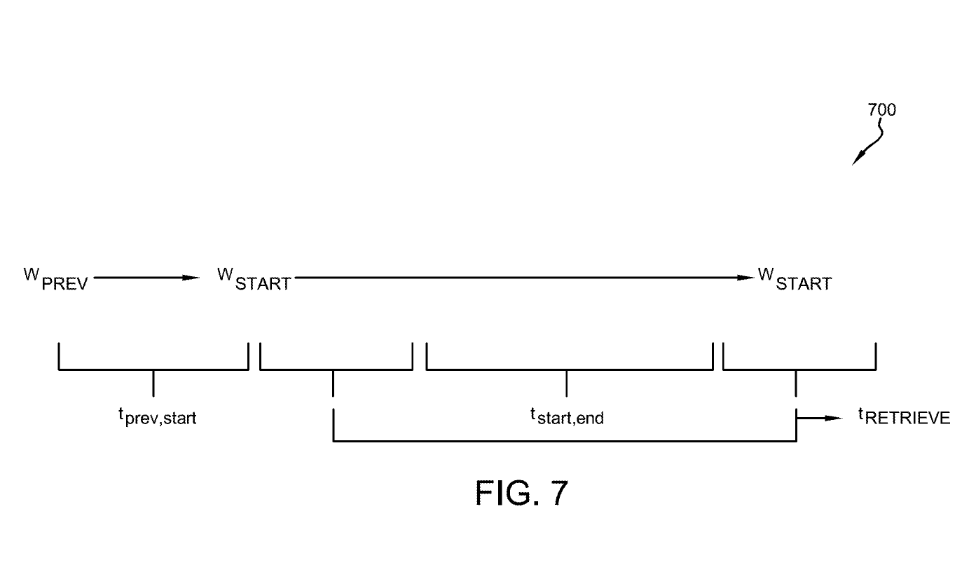

Turning briefly to FIG. 7, a graph 700 is illustrated. The model component can create equations for travel time. Each work order in the chain can lead to one equation which references three (3) variables which creates, for instance, a sparse 0-1 matrix. The result can be an over-determined system, but possibly rank deficient, and/or poorly conditioned. The model component 410 can employ a sparse solution technique(s). Travel times can be resolved between waypoints. For instance, there can be n (n−1) entries if diagonal elements in a matrix are zero, where n is a positive integer.

The model component can provide a solution such as damped least squares (e.g., regularization). The model component indicates values can be distributed around an average, and may affect or improve conditioning of A and A^{T}A. This can solve the normal equations using conjugate gradient method: A^{T}Ax=A^{T}b. However, if values are outside of expected range, one embodiment of the system may increase the damping on those variables and re-solve. A complete travel matrix can be utilized. In another embodiment, an amount of trips can be regulated, and waypoints or locations can be restructured to increase system performance.

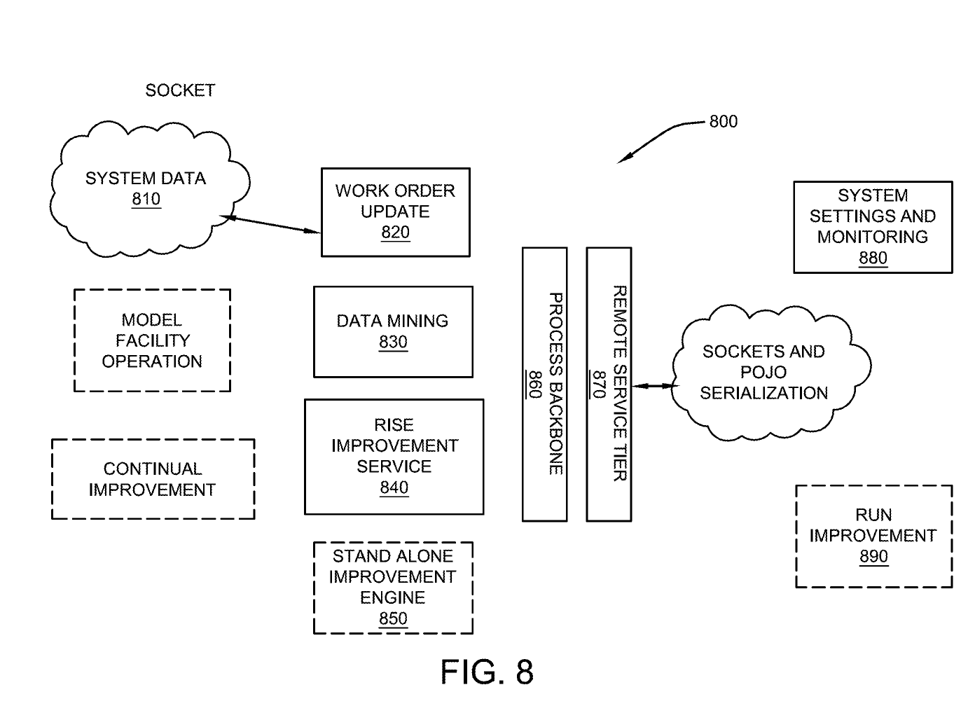

FIG. 8 is an illustration of a system 800 for managing transports of assets within a distribution center. The system can be an embodiment of an architecture that includes a system data (e.g., information data from the distribution center, among others), work order updates 820, data mining 830, improvement services 840 (e.g., RISE improvement service, among others), stand alone improvement engine 850, model facility operation, continual improvement, process backbone 860, remote service tier 870, sockets and POJO (Plain Old Java Object) serialization, system settings and monitoring 880, and run improvement 890.

The aforementioned systems, components, (e.g., transport manager, transport itinerary, work orders, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

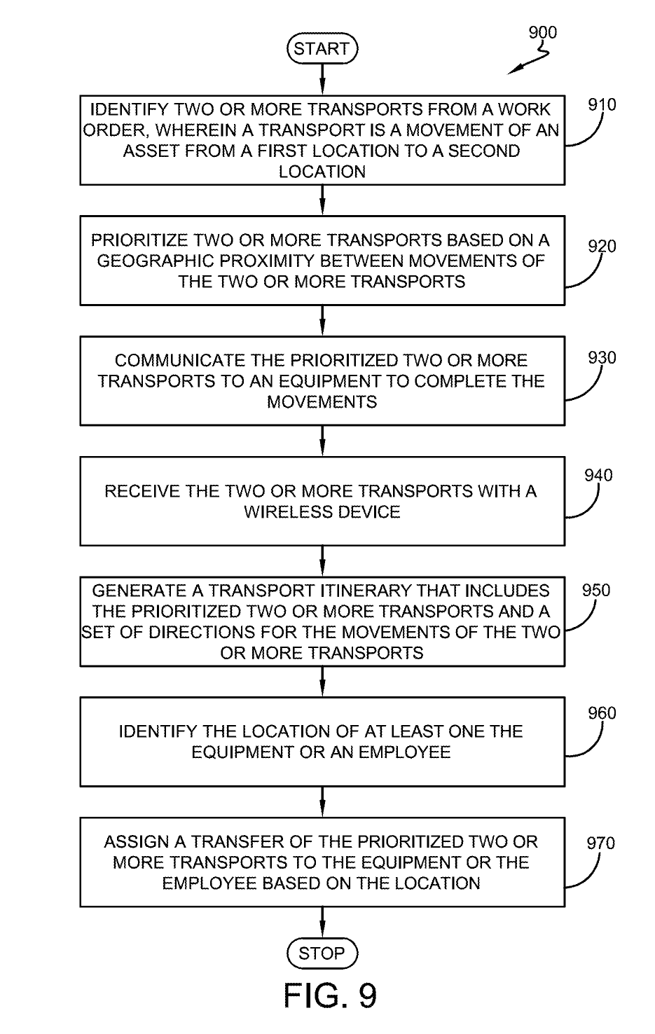

In view of the exemplary devices and elements described supra, methodologies that may be implemented in accordance with the disclosed subject matter will be better appreciated with reference to the flow chart of FIG. 9. While for purposes of simplicity of explanation, the methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 9 illustrates a method 900 for distributing transports to reduce travel time and/or travel distance for the movement of assets within a distribution center. At reference numeral 910, two or more transports from a work order can be identified, wherein a transport is a movement of an asset from a first location to a second location. At reference numeral 920, the two or more transports can be prioritized based on a geographic proximity between movements of the two or more transports. At reference numeral 930, the prioritized two or more transports can be communicated to equipment to complete the movements.

At reference numeral 940, the prioritized two or more transports can be received with a wireless device. At reference numeral 950, a transport itinerary that includes the prioritized two or more transports and a set of directions for the movements can be generated for the two or more transports. At reference numeral 960, a location of at least one of the equipment or a worker can be identified. At reference numeral 970, a transfer of the prioritized two or more transports can be assigned to the equipment or the worker based on the location. (FIG. 9 references an “employee”, but more generally, the method is applicable to workers.)

The method can further include calculating a total distance traveled for the two or more transports based on the location of the equipment or the worker. The method further includes assigning a transfer of the prioritized two or more transports to equipment or an worker based on a location of each, wherein the distribution is based on a lowest total distance traveled. The method further includes identifying a real time geographic location for at least one of the equipment or the worker. The method further includes communicating an additional transport to the equipment or the worker while the equipment or the worker location is between the first location and the second location. The method further includes clearing the work order based on completion of the movement for the two or more transports. The method further includes prioritizing the two or more transports based on at least one of an amount of traffic in a location or a load capacity of the equipment. The method further includes prioritizing the two or more transports based on an area specific event. The area specific event can be at least one of an inoperable equipment, an unavailable worker, a construction of an area, a repair to an area, a power outage for the area, a repair to equipment, an emergency event in the area, or a hazardous condition. The method further includes prioritizing one or more of the transports into a hold itinerary based on the movement of the transport being proximate to the area specific event.

In one embodiment, the prioritizing is based on geographic proximity.

In an embodiment, a device, component, a portion of hardware, a portion of software, a processor, or a combination thereof, can provide at least the following steps: identifying two or more transports from a work order, wherein the transports comprise respective movements of assets from respective first locations to respective second locations; prioritizing the two or more transports based on a geographic proximity between the movements of the two or more transports; and communicating information of the two or more transports as prioritized to equipment to complete the movements.

In an embodiment, a system is provided that includes at least the following: means for defining two or more transports (e.g., via a work order, a device that creates a work order, a transport manager that creates a work order, a computer, a processor, among others), wherein the transports comprise respective movements of assets from respective first locations in a distribution center to respective second locations in the distribution center; means for receiving a geographic location of at least one of a worker or equipment from a device (e.g., via a transport manager, via an asset location component, via a transport itinerary, among others), and to create a transport itinerary that combines at least two of the two or more transports based on an amount of distance traveled for each asset of each transport from the geographic location of the worker or the equipment (e.g., via a transport manager, via an asset location component, via a transport itinerary, among others); and means for communicating the transport itinerary to the device (e.g., via transport manager, a computer, a processor, among others).

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
identifying two or more transports from a work order, wherein the transports comprise respective movements of assets from respective first locations to respective second locations;
prioritizing the two or more transports based on a geographic proximity between the movements of the two or more transports; and
communicating information of the two or more transports as prioritized to equipment to complete the movements.

2. The method of claim 1, further comprising receiving the information of the prioritized two or more transports with at least one device associated with the equipment.

3. The method of claim 1, further comprising generating a transport itinerary that includes the information of the prioritized two or more transports and a set of directions for the movements for the two or more transports.

4. The method of claim 1, further comprising:
identifying a location of at least one of the equipment or a worker; and
assigning a transfer of the prioritized two or more transports to the equipment or the worker based on the location.

5. The method of claim 4, further comprising calculating a total distance traveled for the two or more transports based on the location of the equipment or the worker.

6. The method of claim 5, further comprising re-assigning a transfer of the prioritized two or more transports to equipment or a worker based on respective locations of the equipment or the worker, wherein the re-assigning is based on a lowest total distance traveled.

7. The method of claim 6, further comprising identifying a real time geographic location for at least one of the equipment or the worker.

8. The method of claim 4, further comprising communicating information of an additional transport to the equipment or the worker while the equipment or the worker location is between one of the first locations and one of the second locations.

9. The method of claim 1, further comprising clearing the work order based on completion of the movement for the two or more transports.

10. The method of claim 1, further comprising prioritizing the two or more transports based on at least one of an amount of traffic in a location of the traffic or a load capacity of the equipment.

11. The method of claim 1, further comprising prioritizing the two or more transports based on an area specific event.

12. The method of claim 11, wherein the area specific event is at least one of an inoperable equipment, an unavailable employee, a construction of an area, a repair to the area, a power outage for the area, a repair to equipment, an emergency event in the area, or a hazardous condition in the area.

13. The method of claim 11, further comprising prioritizing one or more of the transports into a hold itinerary based on the movement of the one or more transports being proximate to the area specific event.

14. A system comprising:
a transport manager configured to store a work order and to identify two or more transports from the work order, wherein the transports comprise respective movements of assets from respective first locations to respective second locations;
wherein the transport manager is configured to prioritize the two or more transports based on a geographic proximity between the movements of the two or more transports, and to communicate information of the two or more transports as prioritized to equipment to complete the movements.

15. A system comprising:
a work order that defines two or more transports, wherein the transports comprise respective movements of assets from respective first locations in a distribution center to respective second locations in the distribution center; and
a transport manager configured to receive a geographic location of at least one of a worker or equipment from a device, and to create a transport itinerary that combines at least two of the two or more transports based on an amount of distance traveled for each asset of each transport from the geographic location of the worker or the equipment;
wherein the transport manager is further configured to communicate the transport itinerary to the device.

16. The system of claim 15, wherein the transport manager is configured to clear the work order upon completion of the movements included with the transport itinerary.

17. The system of claim 15, wherein the transports include at least one of drop offs of the assets or pickups of the assets.

18. The system of claim 15, wherein the transport manager is configured to communicate the transport itinerary to the device.

19. The system of claim 18, further comprising the device, wherein the device is at least one of a wireless device, a smartphone, a laptop, a portable digital assistant, a tablet, a mobile computing device, a portable computing device, a personal computer, a computer integrated into a vehicle, or a global positioning service device.

20. The system of claim 15, wherein the transport manager is configured to combine the two or more transports based on an amount of traffic in an area of the distribution center.

21. A system, comprising:
means for defining two or more transports, wherein the transports comprise respective movements of assets from respective first locations in a distribution center to respective second locations in the distribution center;
means for receiving a geographic location of at least one of a worker or equipment from a device, and to create a transport itinerary that combines at least two of the two or more transports based on an amount of distance traveled for each asset of each transport from the geographic location of the worker or the equipment; and
means for communicating the transport itinerary to the device.
